(19) United States
(12) Patent Application Publication
(10) Pub. No.: US 2009/0055245 A1
(43) Pub. Date: Feb. 26, 2009

(54) SURVEY FRAUD DETECTION SYSTEM AND METHOD

(75) Inventors: David R. Bostock, St. Louis Park, MN (US); Jeffrey Stewart, San Francisco, CA (US)

Correspondence Address: DAVIS WRIGHT TREMAINE, LLP/Seattle, 1201 Third Avenue, Suite 2200, SEATTLE, WA, 98101-3045, US

(73) Assignee: MARKETTOOLS, INC., San Francisco, CA (US)

(21) Appl. No.: 12/191,961

(22) Filed: Aug. 14, 2008

Related U.S. Application Data
(60) Provisional application No. 60/950,387, filed on Aug. 15, 2007.

(51) Int. Cl. G06Q 30/00; G06F 17/30

(52) U.S. Cl. 705/10

(57) ABSTRACT

A method of filtering fraudulent responses from survey data including responses to survey questions received from survey takers and a response time for each response. For each question, any responses to the question having a response time less than a minimum time required to provide a thoughtful response are filtered from the survey data. Optionally, for each survey taker, a number of responses filtered from the survey data is determined. If this number exceeds a threshold, all responses provided by the survey taker are filtered from the survey data. The method may determine whether responses provided by each survey taker to attributes of a matrix question include a pattern. If a survey taker's responses include the pattern and were provided in less than the minimum time required to provide a thoughtful response to the matrix question, all responses provided by the survey taker are filtered from the survey data.

### CROSS REFERENCE TO RELATED APPLICATION(S)

This application claims the benefit of U.S. Provisional Application No. 60/950,387, filed Aug. 15, 2007.

### BACKGROUND OF THE INVENTION

1. Field of the Invention

The present invention is directed generally to survey systems for collecting survey data.

2. Description of the Related Art

The accuracy in survey data collected by a survey system from survey takers regarding a survey can suffer when a survey taker enters one or more erroneous responses to the survey that do not accurately reflect the opinions, understanding, or other such knowledge of the survey taker. When a survey taker deliberately responds to a survey in an erroneous manner, the response is referred to as a “fraudulent response” and the data collected by the survey system is known as fraudulent survey data. On the other hand, when the survey taker provides a response that accurately reflects the opinions, understanding, and other such knowledge of the survey taker, the response is referred to as a “thoughtful response” and the data collected by the survey system is believed to represent accurate survey data.

In recent years, surveys conducted online over the Internet have become increasingly popular. In many of these online surveys, the survey taker is offered a reward or incentive, such as a coupon, enrollment in a contest or drawing, and the like, in exchange for completing the online survey. Generally, the survey taker completes the survey without any supervision by the provider of the survey. Unfortunately, to more quickly obtain the incentive, many unsupervised survey takers complete these surveys by providing “fraudulent responses.” For example, many survey takers merely select survey options without even reading the questions or without giving any thought to their responses.

When asked matrix questions or multiple choice questions, many survey takers will provide fraudulent responses by simply selecting the same response (e.g., option “C,” a rating value of one, and the like) for all or a substantial portion of the survey questions. In the survey industry, this practice is commonly referred to as “straight lining.” Matrix questions are questions that present the survey taker with a scale, such as from one to five, and ask the survey taker to select a value within the range that reflects their opinion with respect to the question. For example, a matrix question may ask a survey taker to rate a product on a scale from one to five, five being “excellent,” and one being “poor.” The values between five and one correspond to ratings between “excellent” and “poor.” A typical matrix question includes one or more attributes each soliciting a response according to the scale. For this reason, responding to the attributes of a typical matrix question can be time consuming.

Survey takers provide fraudulent instead of thoughtful responses for a variety of reasons, but whatever the reason, it is advantageous to the accuracy of the survey to detect such fraudulent survey data. Conventional attempts to detect fraudulent survey data include use of pattern matching (e.g. did the survey taker provide the same answer to all of the questions in a particular series) and/or the use of reverse logic (e.g., a first question, such as “how much do you like the color of a product?,” followed by questions that contradict the first question, such as “how much did you dislike the color of the product?”). Unfortunately, conventional approaches can have accuracy problems and can be cumbersome to implement.

Additional prior art methods of fraud detection include determining the total time required by the survey taker to provide responses to all of the survey questions. Then, survey personnel examining the survey response time data determine a threshold amount of time believed to have been required to provide thoughtful responses to all of the survey questions. After this threshold value is determined, all of the responses received from individual survey takers who required less than the threshold amount of time to complete the survey are excluded from the survey response data. In other words, all of the responses received survey takers who completed the survey in less than the threshold amount of time are believed to be fraudulent responses and are excluded from the survey results.

Therefore, a need exists for a more accurate method of detecting fraudulent responses. A less cumbersome and more automated method of detecting fraudulent responses is also desirable. The present application provides these and other advantages as will be apparent from the following detailed description and accompanying figures.

### BRIEF DESCRIPTION OF THE SEVERAL VIEWS OF THE DRAWING(S)

FIG. 1 is a schematic diagram of a computer environment suitable for implementing a survey fraud detection system.

FIG. 2 is an illustration of an exemplary survey fraud detection system.

FIG. 3 is a flow diagram of a method used by the exemplary survey fraud detection system of FIG. 2 to collect survey data including responses to survey questions.

FIG. 4 is a flow diagram of a method used by the exemplary survey fraud detection system of FIG. 2 to filter fraudulent responses to the survey questions from the survey data.

FIG. 5 is a flow diagram of another method used by the exemplary survey fraud detection system of FIG. 2 to filter fraudulent responses to the survey questions from the survey data.

### DETAILED DESCRIPTION OF THE INVENTION

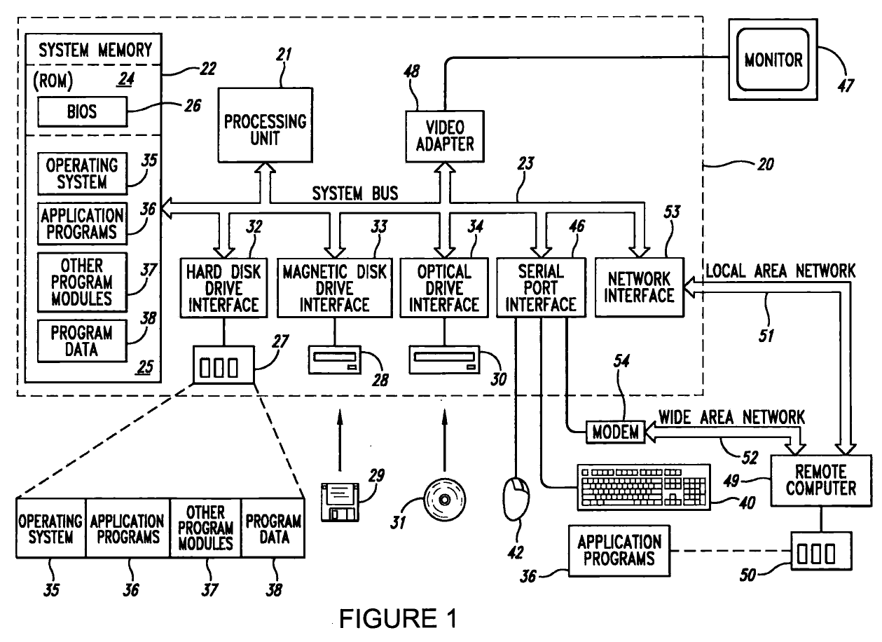

FIG. 1 is a diagram of hardware and an operating environment in conjunction with which implementations of a survey fraud detection system and method may be practiced. The description of FIG. 1 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 1 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, USB drives, digital video disks, Bernoulli cartridges, random access memories (RAMs), read only memories (ROMs), and the like, may be used in the exemplary operating environment.

A number of program modules may be stored on the hard disk drive 27, magnetic disk 29, optical disk 31, ROM 24, or RAM 25, including an operating system 35, one or more application programs 36, other program modules 37, and program data 38. A user may enter commands and information into the computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20 (as the local computer). Implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local area network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device 50. It is appreciated that the network connections shown are exemplary and other means of and communications devices for establishing a communications link between the computers may be used.

The hardware and operating environment in conjunction with implementations that may be practiced has been described. The computer, in conjunction with implementations that may be practiced, may be a conventional computer, a distributed computer, or any other type of computer. Such a computer typically includes one or more processing units as its processor, and a computer-readable medium such as a memory. The computer may also include a communications device such as a network adapter or a modem, so that it is able to communicatively couple to other computers.

The computing device 20 and related components have been presented herein by way of particular example and also by abstraction in order to facilitate a high-level view of the concepts disclosed. The actual technical design and implementation may vary based on particular implementation while maintaining the overall nature of the concepts disclosed.

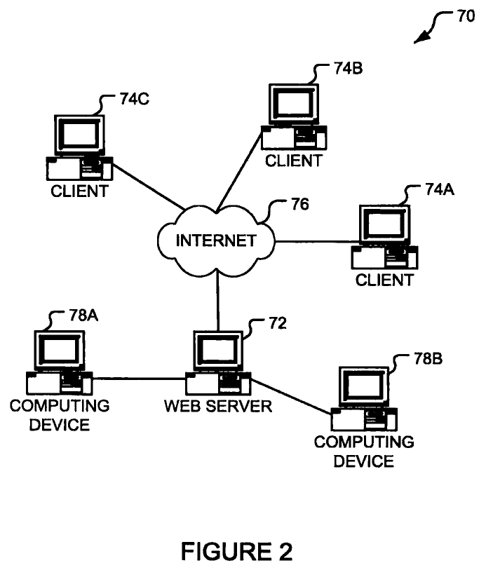

Turning to FIGS. 1 and 2, aspects of the present invention include a survey fraud detection system 70, which includes a web server 72 constructed in general accordance with the remote computer 49 and a plurality of client computers 74A, 74B, and 74C each constructed in general accordance with the computer 20. Optionally, the survey fraud detection system 70 includes one or more optional computing devices 78A and 78B each constructed in general accordance with the computer 20. The survey fraud detection system 70 includes a fraudulent response filter (not shown) that implements a method 200 and optionally, a method 300 both described below. The fraudulent response filter detects fraudulent responses to survey questions and filters them from the survey response data. As is appreciated by those of ordinary skill in the art, the fraudulent response filter may be implemented using software components, hardware components, and a combination thereof. The fraudulent response filter may be incorporated into the web server 72, the computing device 78A, the computing device 78B, a combination thereof, and the like using any method known in the art.

Referring to FIG. 2, the web server 72 is coupled to the client computers 74A, 74B, and 74C by the networking environment described above, which includes the Internet 76. The optional computing devices 78A and 78B may be coupled to the web server 72 by the network environment. However, this is not a requirement.

The web server 72 is configured to send survey questions to the client computers 74A, 74B, and 74C and receive responses to the survey questions from the client computers 74A, 74B, and 74C. The client computers 74A, 74B, and 74C are each configured to receive the survey questions from the web server 72, display the survey questions to the survey taker, receive the survey takers response to the survey questions, and transmit those responses to the web server 72.

As mentioned above, the fraudulent response filter may be incorporated in the web server 72, the computing device 78A, or the computing device 78B. For example, the web server 72 may use the fraudulent response filter to analyze the survey responses received from the client computers 74A, 74B, and 74C. Alternatively, the survey responses may be transferred to or accessed by the computing devices 78A and 78B for analysis using the fraudulent response filter. Thus, at least one of the web server 72 and the computing devices 78A and 78B includes instructions for executing the method 200 and optionally, the method 300 both described below. As is appreciated by those of ordinary skill in the art, such instructions may be stored in any suitable computer readable medium including the system memory 22 or remote memory storage device 50.

As explained above in the Background Section, prior art methods of detecting fraudulent responses examine a total amount of time taken by all of the survey takers to complete all of the survey questions of a survey. Aspects of the present invention are directed toward a method that divides the survey questions of a survey into groups and examines an amount of time required to complete the survey questions in each group separately.

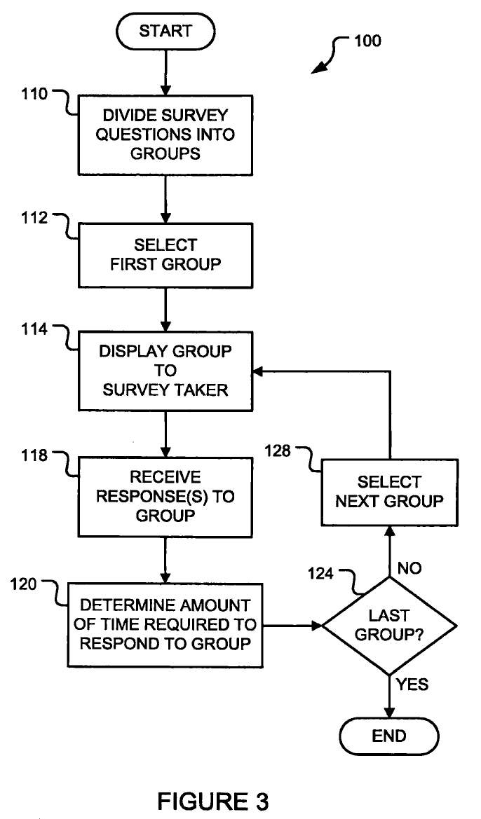

FIG. 3 is flow diagram of a method 100 that may be implemented by the survey fraud detection system 70 of FIG. 2. The method 100 is used to obtain survey data from a survey taker. In first block 110, the survey questions are divided into a plurality of groups. Each group may include a single question or multiple questions.

The survey questions may include one or more matrix questions. Each matrix question includes one or more attribute. As explained above, each attribute of a matrix question solicits a response from the survey taker. Thus, each attribute of a matrix question may be viewed as a sub-question of the matrix question. For each matrix question, its attributes may be included in the same group or divided into multiple groups. When dividing the survey questions into groups, it may be desirable to avoid combining other survey questions with the attributes of a matrix question in the same group. Likewise, it may be desirable to avoid combining attributes from one or more matrix questions in the same group.

In next block 112, one of the groups of survey questions is selected. Then, in block 114, the selected group is displayed to the survey taker. Referring to FIGS. 2 and 3, for illustrative purposes, it will be assumed the survey taker is operating the client computer 74A. In block 114, the web server 72 sends the group of survey questions to the client computer 74A. For example, the web server 72 may send a HTML page to the client computer 74A containing the group of survey questions, which may include a single survey question, one or more attributes of a matrix question, or multiple survey questions. Then, the client computer 74A displays the survey question(s) of the group to the survey taker, and waits for a response to the group from the survey taker.

In block 118, the client computer 74A receives the response(s) from the survey taker. Upon receiving the response(s) from the survey taker, the client computer 74A transmits the response(s) to the web server 72.

In block 120, an amount of time required to respond to the group of survey questions (a “response time”) is determined. The response time may be determined by the client computer 74A, the web server 72, or a combination thereof. For example, the web server 72 may determine the response time by calculating an amount of time that elapsed between sending the group to the client computer 74A and receiving the response(s) from the client computer 74A.

Alternatively, the client computer 74A may determine the response time by calculating an amount of time that elapsed between displaying the group to the survey taker and receiving the response(s) from the survey taker. By way of another example, the client computer 74A may determine the response time by calculating an amount of time that elapsed between receiving the group from the web server 72 and receiving the response(s) from the survey taker. After the client computer 74A determines the response time, the client computer 74A may transmit the response time to the web server 72 with the response(s) to the group.

If the client computer 74A received more than one survey question in the group from the web server 72, the client computer 74A may determine a response time for each question separately. For example, for each question, the client computer 74A may determine the amount of time required by the survey taker to respond to a question by calculating an amount of time that elapsed between displaying the question to the survey taker and receiving the response to the question from the survey taker. The client computer 74A may transmit the amount of time required to respond to each question to the web server 72 with the responses to the survey questions. Alternatively, the web server 72 may determine a response time for each question by dividing the response time for the group by the number of questions in the group.

While several methods of determining how much time was required by the survey taker to respond to one or more questions of the survey have been described, through the application of ordinary skill in the art to the present teachings additional methods may be implemented that are within the scope of the invention.

Likewise, if the client computer 74A received more than one attribute of a matrix question in the group from the web server 72, the client computer 74A may determine a separate response time for each attribute using any of the methods described above as suitable for determining a separate response time for each question in a group including multiple questions.

In next decision block 124 whether the group is the last group of survey questions is determined. If the decision is “NO,” in block 128, the next group is selected and the method returns to block 114. If the decision is “YES,” the method terminates. To collect survey data from a plurality of survey takers, blocks 112-128 of the method 100 are repeated for each of the plurality of survey takers. For example, blocks 112-128 of the method 100 may be used to provide the groups of survey questions to survey takers operating the client computers 74B and 74C and receive responses from those survey takers.

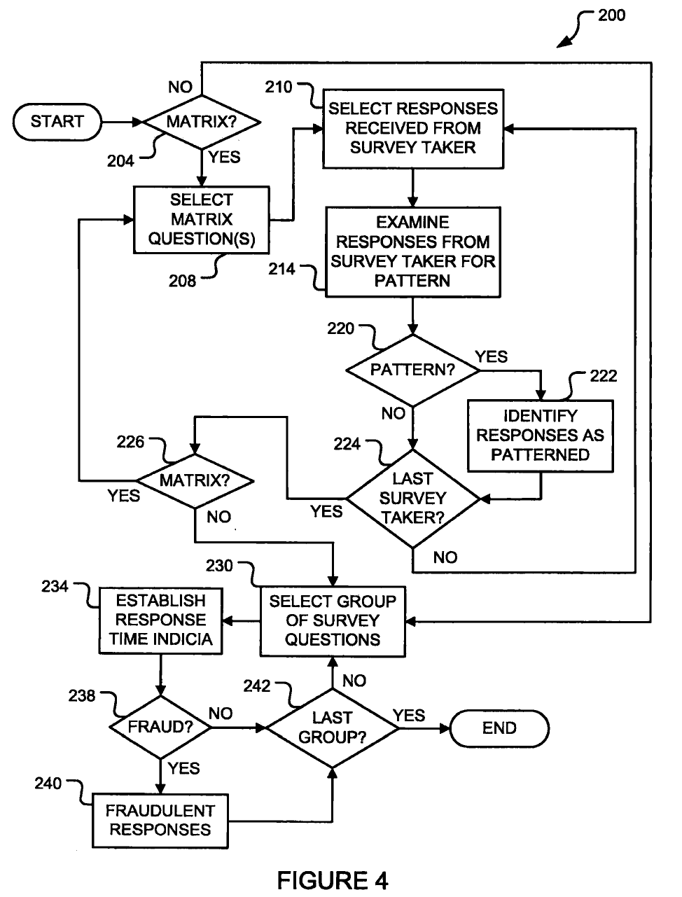

FIG. 4 is a flow diagram of the method 200 of detecting fraudulent responses obtained from performing the method 100 and filtering those fraudulent responses from the survey data. At least one of the web server 72 or the optional computing devices 78A and 78B may perform the method 200.

First decision block 204 determines whether the survey questions include one or more matrix questions. If decision block 204 determines the survey questions include one or more matrix questions, the decision is “YES,” and the method 200 advances to block 208. Otherwise, if decision block 204 determines the survey questions do not include one or more matrix questions, the decision is “NO,” and the method 200 advances to block 230.

In block 208, at least one matrix question is selected. For example, in block 208 all of the matrix questions included in the survey questions may be selected, a single matrix question may be selected, or a set of matrix questions may be selected.

In block 210, the responses to the attributes of the matrix question(s) selected in block 208 received from a single survey taker are selected. In block 214, the responses selected in block 210 are examined to determine whether a pattern exists in the responses.

If decision block 220 decides “YES,” a pattern exists, in block 222 the responses are flagged or identified as patterned. Otherwise, if decision block 220 decides “NO,” a pattern does not exist in the responses. By way of a non-limiting example, decision block 220 decides “YES,” a pattern exists, when all of the responses to all of the attributes of the matrix question(s) selected in block 208 provided by the survey taker are identical. In other words, decision block 220 decides “YES,” a pattern exists when the survey taker has “straight lined” all of the attributes of the matrix question(s) selected in block 208. For example, if the survey taker has responded to a series of matrix questions with the same rating (or ranking) for every attribute, decision block 220 decides “YES,” a pattern exists.

By way of another non-limiting example, decision block 220 decides “YES,” a pattern exists, when more than a threshold number of the responses provided by the survey taker to the attributes of the matrix question(s) selected in block 208 are identical. For example, if the matrix question(s) selected in block 208 included a total of 20 attributes and the survey taker provided the same response to at least 16 attributes (i.e., at least 80% of the attributes), the decision block 220 decides “YES,” a pattern exists.

Alternatively, decision block 220 may use reverse logic to determine a pattern exists. For example, if some of the attributes of the matrix question(s) are related to one another, reverse logic may be used to detect contradictory or nonsensical responses to related attributes. In such embodiments, decision block 220 decides “YES,” a pattern exists when contradictory or nonsensical responses to related attributes are detected. Otherwise, if contradictory or nonsensical responses to related attributes are not detected, the decision block 220 decides “NO,” a pattern does not exist in the responses.

If the decision in decision block 220 is “YES,” the method 200 advances to decision block 222. Otherwise, if the decision in decision block 220 is “NO,” the method 200 advances to decision block 224.

In decision block 224, the method 200 determines whether the responses from the last survey taker have been examined. In other words, the decision block 224 determines whether additional survey responses from another survey taker exist that have not been examined for a pattern. If the decision in decision block 224 is “NO,” responses received from all of the survey takers have not yet been examined, and the method 200 returns to block 210. Otherwise, if the responses received from all of the survey takers have been examined, the decision in decision block 224 is “YES,” and the method 200 advances to decision block 226.

Decision block 226 determines whether the survey questions include one or more matrix questions that have not yet been selected in block 208 and examined for a pattern in block 214. If the decision in decision block 226 is “NO,” all of the matrix questions have been selected in block 208 and examined for a pattern in block 214, and the method 200 advances to block 230. Otherwise, when the survey questions include one or more matrix questions that have not yet been selected in block 208 and examined for a pattern in block 214, the decision in decision block 226 is “YES,” and the method 200 returns to block 208.

In block 230, the method 200 selects a group of survey questions. In block 234, response time indicia for the group is established based upon the response times for the group determined in block 120 of FIG. 3 for each of the survey takers. As discussed above, each group may include a single question, one or more attributes of a matrix question, or multiple questions. Therefore, particular embodiments of block 234 establish response time indicia for each survey question. Other embodiments establish response time indicia for multiple survey questions. Further embodiments establish response time indicia for all or a portion of the attributes of one or more matrix questions. Additional embodiments establish response time indicia for multiple survey questions as well as establish response time indicia for particular ones of the survey questions.

In a first implementation, to establish the response time indicia for the group, the response times are normalized. The normalization process accounts for anomalies such as outliers (e.g., survey takers whose response time to one or more survey questions were unexpected long due to being interrupted while responding to the survey) that would otherwise incorrectly skew the value of the response time indicia. In this first implementation, the logarithm of the response time (“logarithmic value”) for the group is calculated. Then, the mean and standard deviation of the logarithmic values are calculated. Finally, the response time indicia is established at two standard deviations below the mean.

In a second implementation, the response times for the group are normalized by determining a median value (value of the 50^{th} percentile) and standard deviation for the response times. Any response times for the group having values at least two standard deviations above the median value are disregarded. Next, a mean value of the remaining response times is calculated. Optionally, the standard deviation may be recalculated to exclude the disregarded responses. Then, the response time indicia is established at two standard deviations below the mean value.

In a third implementation, for the group, a subjective opinion of one or more individuals, such as experts, is used to arrive at the response time indicia for the group based upon the subjective opinion of how much time is a least amount of time required to provide a thoughtful non-erroneous response to the group. This least amount of time is then established as the response time indicia.

In decision block 238, for each survey taker, the response time required to respond to the group is compared to the response time indicia to determine which responses are fraudulent. For example, in the first implementation, a logarithm of the response time is compared to the response time indicia, which as explained above, is two standard deviations below the mean of the logarithmic values of the response times. In the first implementation, the decision block 238 determines “YES,” a survey response is a fraudulent response when the logarithm of its response time is less than the response time indicia. The decision block 238 determines “NO,” a survey response is not a fraudulent response when the logarithm of its response time is greater than or equal to the response time indicia.

In the second and third implementations, the decision block 238 determines “YES,” a survey response is a fraudulent response when the survey response has a response time less than the response time indicia. The decision block 238 determines “NO,” a survey response is not a fraudulent response when the survey response has a response time greater than or equal to the response time indicia.

If the decision in decision block 238 is “YES,” with respect to a survey response, block 340 determines the response is a fraudulent response and excludes it from the survey data. Then, the method 200 advances to decision block 242.

When the decision in decision block 238 is “NO,” the method 200 advances to decision block 242.

Decision block 242 determines whether the group is the last group. If the group is not the last group, the decision in decision block 242 is “NO,” and the method 200 returns to block 230. Otherwise, if the group is the last group, the decision in decision block 242 is “YES,” and the method 200 terminates.

At the completion of the method 200, some of the responses from a portion of the survey takers may have been excluded from the survey data. Specifically, any responses that were provided in less time than would have been required to provide a thoughtful response have been excluded. In other words, any survey responses having response times less than the response time indicia have been excluded from the survey data by block 240 of the method 200. Consequently, the responses from some survey takers may have been excluded completely and at least a portion of the responses from other survey takers have been excluded.

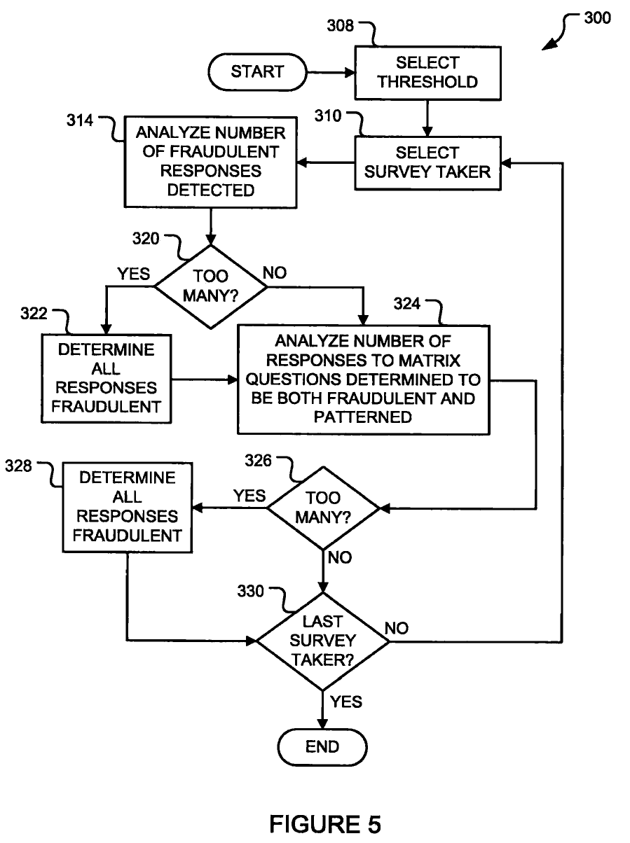

Optionally, the method 300 illustrated in FIG. 5 may be performed after the method 200 to detect additional fraudulent responses in the survey data. In first block 308, a threshold value is selected. By way of a non-limiting example, the threshold value may be a percentage (e.g., 50%, 60%, etc.) representing a minimum percentage of thoughtful responses that must have been provided by a survey taker (or conversely, a maximum number of fraudulent response that may have been provided by the survey taker) to include that survey taker's responses in the survey data. For example, if the survey was divided into 20 groups and the survey taker provided fraudulent responses (as determined by decision block 238 and block 240 above) to 18 groups, the survey taker provided thoughtful responses to only 10% of the groups. Thus, it may be desirable to exclude all of the survey taker's responses. On the other hand, if the survey taker provided fraudulent responses to only two groups, the survey taker provided thoughtful responses to only 90% of the groups. Thus, it may be desirable to include the survey taker's thoughtful responses in the survey data.

Then, block 310 selects the responses received from a single survey taker. In block 314, the responses selected in block 310 are analyzed to determine how many responses were determined to be fraudulent in block 240 of the method 200. By way of a non-limiting example, block 314 may calculate the percentage of responses determined to be fraudulent in block 240 of the method 200.

In decision block 320, the threshold value is compared to the results of the analysis performed in block 314 to determine whether too many of the survey taker's responses were determined to be fraudulent indicating all of the survey taker's responses should be excluded from the survey data.

If decision block 320 decides “YES,” too many of the survey taker's response were determined to be fraudulent in block 240 of the method 200. When this occurs, in block 322, all of survey taker's responses are determined to be fraudulent and are excluded from the survey data. Then, the method 300 advances to block 324. Otherwise, if decision block 320 decides “NO,” fewer than the threshold number of the survey taker's responses were determined to be fraudulent, and the method 300 advances directly to block 324.

Block 324 analyzes the responses to any matrix questions included in the survey questions to determine for how many of the matrix questions the responses provided were determined to be both fraudulent in block 240 of the method 200 and patterned in block 222 of the method 200. In other words, block 324 determines a number of matrix questions for which the survey taker provided “straight-lined” responses in less than the amount of time required to provide a thoughtful response.

Decision block 326 determines whether too many of the survey taker's responses to matrix questions were determined to be both fraudulent and patterned indicating all of the survey taker's responses should be excluded from the survey data. By way of a non-limiting example, decision block 326 may compare the number of fraudulent and patterned responses to matrix questions to a predetermined threshold value. For example, decision block 326 may determine too many of the survey taker's responses to matrix questions were both fraudulent and patterned when all of the survey taker's responses to all of the attributes of all of the matrix questions in the survey were both fraudulent and patterned. By way of another non-limiting example, decision block 326 may determine too many of the survey taker's responses to matrix questions were both fraudulent and patterned when all of the survey taker's responses to all of the attributes of a single matrix question were both fraudulent and patterned. Optionally, the threshold value may have been determined in block 308 described above.

If decision block 326 decides “YES,” too many of the survey taker's response matrix questions were determined to be both fraudulent and patterned. When this occurs, in block 328, all of survey taker's responses are determined to be fraudulent and are excluded from the survey data. Then, the method 300 advances to decision block 330. Otherwise, if decision block 326 decides “NO,” the method 300 advances directly to decision block 330.

In decision block 330, the method 300 determines whether the survey taker selected in block 310 was the last survey taker. In other words, the decision block 330 determines whether additional survey responses from another survey taker are present in the survey data that have not been analyzed in block 314. If the decision in decision block 330 is “NO,” the responses received from all of the survey takers have not been analyzed, and the method 300 returns to block 310 to select another survey taker. Otherwise, if the decision in decision block 330 is “YES,” the responses received from all of the survey takers have been analyzed, and the method 300 terminates.

The methods 200 and 300 offer many advantages over conventional techniques of detecting fraudulent responses to survey questions. First, unlike prior art methods that examine total survey response time, the method 200 considers response times to groups of questions. In this manner, the method 200 may be used to exclude only a portion of the responses provided by a survey taker, instead of all of the survey taker's responses.

By analyzing the number of fraudulent responses provided by a survey taker, the method 300 avoids the inclusion of fraudulent responses that took longer to submit based on reasons unrelated to providing a thoughtful response. For example, a survey taker may have intentionally provided fraudulent responses to every survey question but may have paused during one or more questions long enough to produce a response time large enough to avoid being filtered by the response time indicia. The method 300 filters such responses from the survey data based on the large number of other fraudulent responses provided by the survey taker.

The combination of the methods 200 and 300 avoids the inclusion of fraudulent responses from a survey taker who took a long time supplying a few responses and a very short time supplying the rest. If, as in the prior art, only the aggregate response time are considered, such survey responses would seem valid (or thoughtful). But, in reality, the responses merely represent a long pause taken or interruption that occurred during a few of the questions. By first analyzing the survey questions in groups (including as few as a single question) to detect fraudulent responses and then detecting the number of fraudulent response for a survey taker, such fraudulent responses are easily detected and excluded from the survey data.

Further, because a survey taker's responses to matrix questions reflect the survey taker's level of attention to the survey, excluding all of the responses to a survey provided by a survey taker who provided fraudulent patterned responses to too many of the matrix questions may help insure only thoughtful responses are included in the survey data.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A method for use with a survey comprising a plurality of survey questions, the method comprising:
dividing the plurality of survey questions into a plurality of groups;
displaying each of the plurality of groups one at a time to a plurality of survey takers;
receiving responses to each of the plurality of groups from each of the survey takers, the responses received collectively defining survey data;
for each response received, determining a response time for the response;
establishing a response time indicia for each of the plurality of groups;
for each group, for each response to the group, determining whether the response is a fraudulent response as a function of the response time for the response and the response time indicia for the group; and
excluding from the survey data any response determined to be a fraudulent response.

2. The method of claim 1, further comprising:
determining a threshold percentage; and
for each of at least a portion of the plurality of survey takers,
determining for what percentage of the plurality of groups the responses received from the survey taker were determined to be fraudulent responses, and
excluding from the survey data survey responses received from ones of the portion of the plurality of survey takers whose percentage of fraudulent responses exceeds the threshold percentage.

3. The method of claim 1, further comprising:
determining a threshold value;
for each of at least a portion of the plurality of survey takers, determining a number of fraudulent responses to the plurality of groups that were received from the survey taker; and
for each of the portion of the plurality of survey takers, determining whether to exclude from the survey data survey responses received from the survey taker as a function of the number of fraudulent responses to the plurality of groups that were received from the survey taker, and the threshold value.

4. The method of claim 1, wherein establishing a response time indicia for each of the plurality of groups comprises for each of the plurality of groups:
calculating logarithmic values for the responses to the group received from at least a portion of the plurality of survey takers, the logarithmic values being calculated as a function of the response times for the responses to the group;
calculating a mean logarithmic value of the logarithmic values for the responses to the group;
calculating a standard deviation of the logarithmic values for the responses to the group; and
establishing the response time indicia for the group as two standard deviations below the mean logarithmic value.

5. The method of claim 4, wherein for each group, and for each response to the group, determining whether the response is a fraudulent response as a function of the response time for the response and the response time indicia for the group comprises:
calculating a logarithmic value of the response time of the response; and
comparing the logarithmic value of the response time of the response to the response time indicia, the response being determined to be a fraudulent response when the logarithmic value of the response time of the response is less than the response time indicia.

6. The method of claim 1, wherein determining a response time indicia for each of the plurality of groups comprises for each of the plurality of groups:
calculating a first mean value of the response times for the responses to the group;
calculating a standard deviation of the response times for the responses to the group;
identifying any responses having response times greater than two standard deviations over the first mean value;
calculating a second mean value of the response times for the responses to the group not identified as having response times greater than two standard deviations over the first mean value; and
establishing the response time indicia for the group as a function of the second mean value.

7. The method of claim 6, wherein for each group, and for each response to the group, determining whether the response is a fraudulent response as a function of the response time for the response and the response time indicia for the group comprises:
comparing the response time of the response to the response time indicia, the response being determined to be a fraudulent response when the response time of the response is less than the response time indicia.

8. The method of claim 1 for use with a survey comprising a matrix question having a plurality of attributes, the method further comprising:
receiving responses to the plurality of attributes of the matrix question from the plurality of survey takers, for each survey taker, the responses to the plurality of attributes of the matrix question collectively comprising a response to the matrix question;
analyzing the responses received from each of at least a portion of the plurality of survey takers to the plurality of attributes of the matrix question to determine whether the responses to the plurality of attributes of the matrix question comprise a pattern;
for each of the portion of the plurality of survey takers, determining whether a fraudulent responses to the matrix question was received from the survey taker; and
for each of the portion of the plurality of survey takers, excluding from the survey data survey responses received from the survey taker based on the whether a fraudulent responses to the matrix question was received from the survey taker, and whether the responses to the plurality of attributes of the matrix question received from the survey taker comprise the pattern.

9. The method of claim 8, wherein analyzing the responses received from each of at least a portion of the plurality of survey takers to the plurality of attributes of the matrix question to determine whether the responses to the plurality of attributes of the matrix question comprise the pattern comprises:
for each of the portion of the plurality of survey takers, determining whether the survey taker provided identical responses to each of the plurality of attributes of the matrix question.

10. The method of claim 8, wherein analyzing the responses received from each of at least a portion of the plurality of survey takers to the plurality of attributes of the matrix question to determine whether the responses to the plurality of attributes of the matrix question comprise the pattern comprises:
determining a threshold number; and
for each of the portion of the plurality of survey takers, determining whether the survey taker provided identical responses to more than the threshold number of each of the plurality of attributes of the matrix question.

11. The method of claim 8, wherein analyzing the responses received from each of at least a portion of the plurality of survey takers to the plurality of attributes of the matrix question to determine whether the responses to the plurality of attributes of the matrix question comprise the pattern comprises:
for each of the portion of the plurality of survey takers, determining whether the survey taker provided contradictory responses to two or more of the plurality of attributes of the matrix question.

12. The method of claim 1 for use with a survey comprising a plurality of matrix questions each comprising a plurality of attributes, the method further comprising:
receiving responses to the plurality of attributes of the plurality of matrix questions from the plurality of survey takers, for each survey taker, the responses to the plurality of attributes of each of the plurality of matrix questions collectively comprising a response to the matrix question;
analyzing the responses received from each of at least a portion of the plurality of survey takers to the plurality of attributes of the plurality of matrix questions to determine whether the responses comprise a pattern;
for each of the portion of the plurality of survey takers, determining a number of fraudulent responses to the plurality of matrix questions that were received from the survey taker; and
for each of the portion of the plurality of survey takers, excluding from the survey data survey responses received from the survey taker based on the number of fraudulent responses to the plurality of matrix questions that were received from the survey taker, and the determination of whether the responses comprise the pattern.

13. The method of claim 12, wherein analyzing the responses received from each of the portion of the plurality of survey takers to the plurality of attributes of the plurality of matrix questions to determine whether the responses comprise the pattern comprises:
for each of the portion of the plurality of survey takers, determining whether the survey taker provided identical responses to each of the plurality of attributes of the plurality of matrix questions.

14. The method of claim 12, wherein analyzing the responses received from each of the portion of the plurality of survey takers to the plurality of attributes of the plurality of matrix questions to determine whether the responses comprise the pattern comprises:
determining a threshold number; and
for each of the portion of the plurality of survey takers, determining whether the survey taker provided identical responses to more than the threshold number of the plurality of attributes of the plurality of matrix questions.

15. The method of claim 12, wherein analyzing the responses received from each of the portion of the plurality of survey takers to the plurality of attributes of the plurality of matrix questions to determine whether the responses comprise the pattern comprises:
for each of the portion of the plurality of survey takers, determining whether the survey taker provided contradictory responses to two or more of the plurality of attributes of the plurality of matrix questions.

16. A method for use with a survey comprising a plurality of survey questions, the method comprising:
displaying each of the plurality of survey questions one at a time to a plurality of survey takers;
receiving responses to the plurality of survey questions from each of the plurality of survey takers, the responses received collectively defining survey data;
for each response received, determining a response time for the response;
establishing a response time indicia for each of the plurality of survey questions;
for each response to each of the plurality of survey questions, determining whether the response is a fraudulent response to the survey question as a function of the response time of the response and the response time indicia of the survey question; and
excluding from the survey data any response determined to be a fraudulent response.

17. The method of claim 16 for use with a survey comprising a plurality of survey questions including a matrix question comprising a plurality of attributes, the method further comprising:
analyzing the responses received from each of the plurality of survey takers to the plurality of attributes of the matrix question to determine whether the responses to the plurality of attributes of the matrix question comprise a pattern; and
excluding from the survey data responses received from any survey taker whose response to the matrix question is determined to be a fraudulent response and whose responses to the plurality of attributes of the matrix question are determined to comprise the pattern.

18. The method of claim 16, further comprising:
for each of at least a portion of the plurality of survey takers, determining a number of fraudulent responses to the plurality of survey questions that were received from the survey taker,
for each of the portion of the plurality of survey takers, determining whether to exclude from the survey data the survey responses received from the survey taker as a function of the number of fraudulent responses.

19. A method of filtering fraudulent responses from survey data, the survey data comprising a plurality of responses to each of a plurality of survey questions and a response time for each response, the plurality of responses having been provided by a plurality of survey takers, the method comprising:
determining a minimum amount of time required to provide a thoughtful response to each of the plurality of survey questions; and
for each of the plurality of survey questions, filtering from the survey data each response having a response time that is less than the minimum amount of time required to provide a thoughtful response to the survey question.

20. The method of claim 19 for use with survey data comprising a plurality of responses to sub-questions of one of the plurality of survey questions, the plurality of responses to the sub-questions of the one of the plurality of survey questions together comprising a response to the one of the plurality of survey questions, and a response time for the response to the one of the plurality of survey questions, the method comprising:
identifying a pattern;
for each of at least a portion of the plurality of survey takers, determining whether the survey taker provided responses to the sub-questions of the one of the plurality of survey questions that comprise the identified pattern;
filtering from the survey data all of the responses provided by a survey taker who provided responses to the sub-questions of the one of the plurality of survey questions that comprise the identified pattern and provided a response to the one of the plurality of survey questions having a response time that is less than the minimum amount of time required to provide a thoughtful response to the one of the plurality of survey questions.

21. The method of claim 19, further comprising:
identifying a threshold number; and
for each of the plurality of survey takers, determining whether more than the threshold number of responses provided by the survey taker to the plurality of survey questions have been filtered from the survey data;
for each of the plurality of survey takers having more than the threshold number of responses provided by the survey taker filtered from the survey data, filtering any responses remaining in the survey data that were provided by a survey taker from the survey data.

22. A computer-readable medium comprising instructions that when executed by a processor perform a method of filtering fraudulent responses from survey data, the survey data comprising a plurality of responses to each of a plurality of survey questions and a response time for each response, the plurality of responses having been provided by a plurality of survey takers, the method comprising:
determining a minimum amount of time required to provide a thoughtful response to each of the plurality of survey questions; and
for each of the plurality of survey questions, filtering from the survey data each response having a response time that is less than the minimum amount of time required to provide a thoughtful response to the survey question.

23. A system comprising:
a network;
a server coupled to the network, the server comprising survey data and a survey having a plurality of survey questions, the server being configure to divide the plurality of survey questions into a plurality of groups, each group comprising at least one survey questions, and transmit the plurality of groups over the network;
a computing device coupled to the server by the network and configured to receive each of the plurality of groups from the server over the network and display the plurality of groups one at a time to a survey taker, the computing device being further configured to receive at least one response to each of the plurality of groups from the survey taker and transmit the at least one response to each of the plurality of groups to the server, the server being configured to add the at least one response to each of the plurality of groups to the survey data, at least one of the server and computing device being configured to determine a response time for each group, each response time being representative of an amount of time required by the survey taker to respond to the group; and
a fraudulent response filter having a predetermined pattern, the fraudulent response filter being configured to determine for each of the plurality of groups, a minimum amount of time required to provide a thoughtful response to the group and to filter the response to the group provided by the survey taker from the survey data if the response time of the response provided by the survey taker is less than the minimum amount of time required to provide a thoughtful response to the group.

24. The system of claim 16, wherein the fraudulent response filter comprises a threshold number and is further configured to determine whether more than the threshold number of responses provided by the survey taker were filtered from the survey data, and if so, filter any remaining responses provided by the survey taker from the survey data.

25. The system of claim 24, wherein a first question of the plurality of survey questions comprises a plurality of sub-questions, and the fraudulent response filter is further configured to:
determine whether the first question was filtered from the survey data;
determine whether the plurality of sub-questions of the first question comprise a pattern; and
if the fraudulent response filter determines the first question was filtered from the survey data, and the plurality of sub-questions of the first question comprise a pattern, filter any remaining responses provided by the survey taker from the survey data.
